(19) United States
(12) Patent Application Publication
(10) Pub. No.: US 2022/0414795 A1
(43) Pub. Date: Dec. 29, 2022

(54) CROP DISEASE PREDICTION AND TREATMENT BASED ON ARTIFICIAL INTELLIGENCE (AI) AND MACHINE LEARNING (ML) MODELS

(71) Applicant: HIJO IP PTE LTD., Singapore (SG)

(72) Inventors: Rosanna Fores, Makati City (PH); Val Quimno, Davao City (PH); Gilbert Importante, Tagum City (PH); Cecirly Puig, Davao Del Norte (PH)

(73) Assignee: HIJO IP PTE LTD., Singapore (SG)

(21) Appl. No.: 17/265,131

(22) PCT Filed: Nov. 18, 2020
(86) PCT No.: PCT/SG2020/050670

§ 371 Date: Feb. 1, 2021

(51) Int. Cl. G06Q 50/02; G06N 20/00

(52) U.S. Cl. CPC G06Q 50/02; G06N 20/00

(57) ABSTRACT

Examples relate to determining a prediction of a disease likely in a plant in a crop plantation. Examples comprise receiving data captured from a first geo position of a plant in a crop plantation, the data indicating the first geo position; at least one environmental variable; and an indication of a plant disease. Machine learning is used to predict a likelihood of the disease being present in a second plant at a second geo position, based on the received data; first and second historical records of the first and second geo positions respectively; and first and second environmental variables indicating the local environment at the first and second geo positions respectively. A disease indicator is generated, indicating the likelihood of the disease being present in the second plant, and provided to a treatment unit to treat the second plant and reduce the likelihood of the disease occurring at the second plant.

### TECHNICAL FIELD

The present disclosure relates to apparatus and methods of crop disease prediction, for example, predicting the likelihood of a crop becoming diseased in the near future, and treating the crop to reduce the disease presence in the crop plantation. Aspects of this disclosure relate to apparatuses, distributed computing networks, methods, computer software and computer-readable media.

### BACKGROUND

Traditionally, crop plantations, such as those in plantations, fruit farms, cereal farms, and vineyards, conduct blanket aerial spraying as well as manual spraying to mitigate against various plant diseases and infections. However, such blanket spraying can adversely affect healthy plants as well as treating the infected/diseased plants, and unnecessarily using substances to treat plants which do not require treatment releases a greater amount of the substance into the soil and environment which is undesirable as well as unnecessarily consuming treatment substance. It would be better to be able to target spraying onto the infected plants and avoid spraying healthy plants. It may also be an improvement to crop management if there was a proactive and predictive way to determine where disease is likely to occur in a plantation, so it may be treated before it develops and spreads through the crop (as opposed to a reactive approach of noting that a disease is already present are treating it after it has developed).

Blanket spraying can give rise to problems including: inefficient agro yield, high rejection rate of healthy plants (e.g. fruit), a high cost of aerial spraying, being a time consuming process, being an ineffective geographical coverage of the farm/plantation, widespread pesticide contamination in the farm/plantation, and damage to the environment due to pesticide residues. Improving the identification of plants requiring spraying, and performing targeting spraying on these diseased plants, may help address these challenges.

It is an aim of the present invention to address one or more of the disadvantages associated with the prior art.

### SUMMARY OF THE INVENTION

Aspects and examples of this disclosure provide apparatuses, networked devices, methods, and computer software (e.g. stored on computer-readable media) as claimed in the appended claims.

According to an aspect of the present invention there is provided an apparatus comprising:
a processor;
a memory coupled to the processor; and
computer-readable instructions stored on the memory which, when run on the processor, cause the apparatus to:
receive data captured from a first geo position of a plant in a crop plantation, the data indicating:
   the first geo position;
   at least one environmental variable at the first geo position from:
   temperature, humidity, rainfall, soil condition and dewpoint
   an indication of a plant disease, of a first plant at the first geo position;
predict, using a machine-learning, ML, model, a likelihood of the disease being present in a second plant at a second geo position different to the first geo position in a predetermined timeframe, based on:
   the received data;
   a first historical record of the first geo position indicating one or more of: previous plant disease, treatment of previous plant disease, and historical environmental variable values from: temperature, humidity, rainfall, soil condition and dewpoint;
   a first environmental variable indicating the local environment at the first geo position,
   a second historical record of a second geo position indicating one or more of: previous plant disease, treatment of previous plant disease, and historical environmental variable values from: temperature, humidity, rainfall, soil condition and dewpoint; and
      a second environmental variable indicating the local environment of the second geo position; and
provide a disease indicator of the likelihood of the disease being present in the second plant to a treatment unit, the disease indicator to cause treatment of the second plant at the second geo location by the treatment unit according to the predicted likelihood of disease, to reduce the likelihood of the disease occurring at the second plant.

By predicting the likelihood of the disease being present in a second plant at a second geo position through consideration of combinations of various factors such as the weather, temperature, and soil condition, and how they are known to have previously affected the spread of disease in infected plants and potentially infected plants, an accurate and dynamic prediction of disease spread may be obtained.

By indicating the likelihood of the disease being present in a different location, targeted treatment of the plantation may be effected where it is needed, and treatment may be avoided where it is unlikely to be required. For example, a map may be generated of a farm or plantation, indicating GPS locations where disease treatment should be made. Such a map may be computationally scanned, for example by a drone-mounted camera, and images of identified plants may be automatically obtained, for example to verify the prediction of a disease being present, and/or to record the application of a treatment to those plants identified as being likely to be diseased.

A plant disease may be, for example, an insect infestation, fungus, lack of nutrients, lack of viable growth environment, or other cause of detrimental growth or yield of the plant.

The computer-readable instructions, when run on the processor, may cause the apparatus to:
use the trained ML model to predict a likely severity of the disease predicted to be present at the second plant; and
provide a severity indication of the predicted likely severity of the disease being present to the treatment unit, the severity indication to cause treatment of the second crop at the second geo location according to the determined likely severity of the disease.

The indication of the plant disease may be obtained from an artificial intelligence, AI, model, wherein:
the AI model is trained using experimental control data indicating, for each control plant of a plurality of control plants, an image of the control plant, one or more plant diseases or plant disease absence of the control plant, and a plurality of environmental parameters of the control plant, and
the trained AI model receives, as input, a captured image of the first plant, and determines, as output, based on the training data, the indication of the plant disease for the plant in the captured image.

The plurality of control plants may have a similar characteristic to the first plant, such as being the same species, the same batch of crops, the same fruit or grain yield, and/or the same age, for example.

Training the ML model may be performed according to an initial training phase comprising:
receiving a series of training data entries each indicating, for a training plant:
   at least one environmental parameter from: temperature, humidity, rainfall, soil condition and dewpoint;
   an indication of a training plant disease; and
   a training historical record indicating one or more of: previous training plant disease, treatment of previous training plant disease, and historical training plant environmental variable values from: temperature, humidity, rainfall, soil condition and dewpoint; and
determining relationships between the training data entries to allow for prediction of the likelihood of the plant disease for another plant.

Training the ML model may be performed according to a feedback training phase comprising:
receiving a further data entry indicating, for the first plant:
   the first geo position;
   the at least one environmental variable at the first geo position from: temperature, humidity, rainfall, soil condition and dewpoint
   the indication of a plant disease, and
   a first historical record of the first geo position indicating one or more of: previous first plant disease, treatment of previous first plant disease, and historical first plant environmental variable values from: temperature, humidity, rainfall, soil condition and dewpoint; and
determining relationships between the training data entries and the further data entry to allow for prediction of the likelihood of the plant disease for another plant.

The ML training modelling may comprise using propositional logic to determine the relationships.

Training the ML model may comprise:
comparing the prediction of the likelihood of the plant disease obtained in the initial training phase of the ML model with the experimental control data indicating one or more plant diseases or plant disease absence of a control plant, to determine a lag time between the effect of changing a parameter of the set of environmental parameters and a resultant effect on the plant disease; and
providing the determined lag time as input to the ML model for the compared prediction and experimental control data to train the ML model to determine a relationship between a change in an environmental parameter and determined lag time.

The ML model may be configured to use Bayesian probability analysis to predict the likelihood of the disease being present in the second plant in the predetermined timeframe.

The disease indicator may indicate: the second geo location of the second plant; and one or more treatment parameters from: the disease type, the treatment substance type, the plant type, a volume of treatment substance to apply, a concentration of treatment substance to apply, a plant location to treat on the second plant; and a treatment schedule indicating when to treat the second plant.

The first plant in the crop plantation may have an associated unique identifier; and the computer-readable instructions stored on the memory, when run on the processor, may cause the apparatus to:
retrieve the first historical record and the first environmental variable from a database of historical records and a database of environmental variables using the unique identifier; and
store the at least one environmental variable and the indication of a plant disease of the first plant at the first geo position with the unique identifier for subsequent use as training data to train the ML model.

According to another aspect of this disclosure, there is provided a disease recognition apparatus comprising:
a processor;
a memory coupled to the processor; and
computer-readable instructions stored on the memory which, when run on the processor, cause the apparatus to:
receive, as training input, control data from a control plant in experimental control conditions, the control data indicating an image of the control plant, a disease of the control plant in an environment having a set of environmental parameters, and data representing the set of environmental parameters;
establish, from the received training input, a knowledge library of plant diseases according to plant appearance and environmental parameters;
subsequently receive, as use input, a captured image of a crop plantation plant;
determine, based on the received captured image and the knowledge library, a disease of the crop plantation plant; and
provide, as output, an indication of the crop plantation plant disease in the captured image.

According to another aspect of this disclosure, there is provided a device network for agricultural crop treatment, the device network comprising:
any disease recognition apparatus disclosed herein configured to provide an indication of the crop plantation plant disease;
any apparatus disclosed herein configured to provide a disease indicator of the likelihood of the disease being present in the second plant to a treatment unit; and
a treatment unit configured to receive the disease indicator.

The device network may further comprising a field device configured to one or more of:
capture and transmit the geo position and the at least one environmental parameter at the geo position data in the crop plantation to any apparatus described herein; and
capture and transmit, as use input, the captured image of the crop plantation plant to any disease recognition apparatus disclosed herein.

The treatment unit may comprise a drone configured to:
receive the disease indicator comprising a geo location of the second plant and a treatment to apply to the second plant;
travel to the second plant at the geo location; and
apply the treatment indicated in the disease indicator to the plant.

The device network may further comprise:
a storage server in communicative connection with any apparatus disclosed herein, and any disease recognition apparatus disclosed herein, the storage server configured to store one or more of:
the transmitted captured data from the geo position in the crop plantation; and
training data used to train the AI model.

According to another aspect of this disclosure, there is provided a computer-implemented method comprising:
receiving data captured from a first geo position of a plant in a crop plantation, the data indicating:
   the first geo position;
   at least one environmental variable at the first geo position from:
   temperature, humidity, rainfall, soil condition and dewpoint; and
   an indication of a plant disease, of a first plant at the first geo position;
predicting, using a machine-learning, ML, model, a likelihood of the disease being present in a second plant at a second geo position different to the first geo position in a predetermined timeframe, based on:
   the received data;
   a first historical record of the first geo position indicating one or more of: previous plant disease, treatment of previous plant disease, and historical environmental variable values from: temperature, humidity, rainfall, soil condition and dewpoint;
   a first environmental variable indicating the local environment at the first geo position,
   a second historical record of a second geo position indicating one or more of: previous plant disease, treatment of previous plant disease, and historical environmental variable values from: temperature, humidity, rainfall, soil condition and dewpoint; and
   a second environmental variable indicating the local environment of the second geo position; and
providing a disease indicator of the likelihood of the disease being present in the second plant to a treatment unit, the disease indicator to cause treatment of the second plant at the second geo location by the treatment unit according to the predicted likelihood of disease, to reduce the likelihood of the disease occurring at the second plant.

According to another aspect of this disclosure, there is provided computer software which, when executed, is arranged to perform any method disclosed herein.

According to another aspect of this disclosure, there is provided a non-transitory, computer-readable storage medium storing instructions thereon that, when executed by one or more electronic processors, causes the one or more electronic processors to carry out any method disclosed herein.

That is, there is provided a non-transitory computer-readable storage medium having executable instructions stored thereon which, when executed by a processor, cause the processor to:
receive data captured from a first geo position of a plant in a crop plantation, the data indicating:
   the first geo position;
   at least one environmental variable at the first geo position from:
   temperature, humidity, rainfall, soil condition and dewpoint
   an indication of a plant disease, of a first plant at the first geo position;
predict, using a machine-learning, ML, model a likelihood of the disease being present in a second plant at a second geo position different to the first geo position in a predetermined timeframe, based on:
   the received data;
   a first historical record of the first geo position indicating one or more of: previous plant disease, treatment of previous plant disease, and historical environmental variable values from: temperature, humidity, rainfall, soil condition and dewpoint;
   a first environmental variable indicating the local environment at the first geo position,
   a second historical record of a second geo position indicating one or more of: previous plant disease, treatment of previous plant disease, and historical environmental variable values from: temperature, humidity, rainfall, soil condition and dewpoint; and
   a second environmental variable indicating the local environment of the second geo position; and
provide a disease indicator of the likelihood of the disease being present in the second plant to a treatment unit, the disease indicator to cause treatment of the second plant at the second geo location by the treatment unit according to the predicted likelihood of disease, to reduce the likelihood of the disease occurring at the second plant.

Within the scope of this application it is expressly intended that the various aspects, examples and alternatives set out in the preceding paragraphs, in the claims and/or in the following description and drawings, and in particular the individual features thereof, may be taken independently or in any combination. That is, all examples and/or features of any example can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of this disclosure will now be described, by way of example only, with reference to the accompanying drawings, in which:

FIGS. 1a-1b show examples of computer apparatus which operate a ML engine to receive field data for a diseased plant and predict other plants which also require treating for that disease, according to examples disclosed herein;

FIG. 2 illustrates a logic process of training the ML engine to predict diseases in a plant based on determining relationships between different parameters from experimental input data;

FIG. 3 illustrates a logic process of training the ML engine to provide a determination of whether a disease is likely to be present in a plant, according to examples disclosed herein;

FIGS. 4a and 4b show examples of initial and feedback training of computer apparatus which operate a ML model with data on disease in plants, to allow for the ML model to predict future disease in other plants, according to examples disclosed herein;

FIG. 5 shows an example of a computer apparatus which operates an AI recognition engine which is trained with experimental data indicating diseases in plants and the effect of environmental factors to identify disease in other plants, according to examples disclosed herein;

FIG. 6 indicates a combined process 600 of training a ML model to recognise where disease may be likely, and using the trained ML model to predict the disease occurring in another plant, according to examples disclosed herein;

FIG. 7 shows schematically a data record of a disease indication, according to examples disclosed herein;

FIG. 8 shows an example computing network for receiving data on a diseased plant and providing data to a treatment unit to treat other plants for the disease, according to examples disclosed herein; and

FIGS. 9 and 10 show example methods according to examples disclosed herein.

### DETAILED DESCRIPTION

It may be advantageous to be able to provide targeted substance application to crops which are diseased, or are likely to become diseased, rather than blanket-treat a whole plantation area with a treatment substance once disease has been identified (e.g. fungicide, herbicide, pesticide). That is, it may be advantageous to be able to proactively and predictively manage plant disease in a plantation, rather than reactively address issues with plant health once they have arisen (and possibly spread out through the plantation).

Blanket spraying affects healthy plants as well as the infected/diseased plants, and can give rise to issues an inefficient agro yield, high rejection rate of healthy crops, a high cost of spraying large areas (both in operating the spraying machinery and providing the substance to be applied to the plants), being a time consuming process, being an ineffective geographical coverage of the farm/plantation, widespread pesticide contamination in the farm/plantation and damage to the environment due to pesticide residues (these latter two points may be particularly applicable in an organic farming setting, which seeks to minimise chemical treatment of crops). Improving the identification of plants requiring spraying, and performing targeting spraying on these diseased plants, may help address these challenges.

Examples disclosed herein use a machine learning (ML) model to identify plants which are likely to be affected by a disease so that those identified plants may be treated (e.g. with a disease treating substance such as a fungicide) while leaving healthy plants untreated. Examples disclosed herein use an artificial intelligence (AI) based system to analyse an image of a plant and, based on previous plant images and associated data, a conclusion may be made whether the plant has, or is likely to have a disease in future. Examples disclosed herein include computer networks allowing image capture of a plant growing under a set of conditions, and through AI recognition of a disease of that plant, with ML based prediction of other plants in related conditions, indicate where there are other plants which would benefit from being treated for the disease of the imaged plant. Some such examples involve indicating which plants need treating for disease to a drone which can provide the required treatment to those plants without requiring human intervention, i.e. provide an automated system for plant treatment.

Examples discussed in this disclosure relate to a banana plantation and associated diseases (such as Sigatoka (leaf spot)), Bunchy-top aphid carrier, Black leaf streak (BLS)/Black Sigatoka, Banana bunchy top disease (BBTD), Banana wilt, Moko disease and Cigar tip rot). However, it will be appreciated that examples in the disclosure may also be applied to many different types of crops and plantations, such as other fruit and vegetable plants, cereals and grain plantations, and vineyards, for example.

As an overview of the problems which may be addressed, and how they may be addressed, by examples disclosed herein, firstly the present way to treat diseases in plantations may be considered. Currently in plantations, plant disease can happen, and it is treated reactively. That is, disease is observed, and at that point a treatment is applied in reaction to the disease being present and observed. Further, to help stop the spread of diseases in plants once the disease has been observed, usually the farm/plantations are treated by blanket aerial spraying of treatments such as insecticides and pesticides. Problems with this reactive approach include there being no way to proactively predict the spread of plant disease. Also, the manual spraying of treatments by agro workers can be ineffective given the inaccessibility of portions of the plantation to workers (e.g. high plant tops or closely planted crops). To overcome the issue of inaccessibility, a blanket aerial spray is carried out. However, the blanket aerial spray results in contamination of healthy plants as well as treating infected plants. Soil contamination can occur due to treatment substance (e.g, insecticide) residue passing into the ground. This can create an environmental hazard, especially water table contamination. Further, due to treating all the plants regardless of them being diseased or not, there can be a high rate of rejection of the agro yield, and this rejection rate as well as high use of treatment substances can escalate the cost of agro production.

Examples disclosed herein may improve on the abovedescribed reactive methods of plantation treatment, by predicting the likelihood of disease in plants well in advance of the disease occurring. Thus a preventative approach can be taken to stop diseases occurring in the first place. Blanket aerial spraying can be replaced due to targeting particular plants or plant portions as indicated by the example systems disclosed. Certain examples disclosed herein in banana plantations have been shown to result in up to a 90% reduction in plant disease infection rate, with an enhanced agro yield with a 75% reduction in rejection rate. The levels of soil contamination and environmental hazard can be reduced to zero or near-zero through targeted substance application to only those plants which are likely to require it in a preventative, rather than a reactive, treatment programme.

These effects are achieved, for example, by using a system comprising a field worker application running on a portable communications device sch as a smartphone, and/or drones programmed to operate with the backend systems. The backend system may comprise a (e.g. cloud) server for data storage, an Artificial Intelligence Engine, and a Machine Learning Engine, which are configured to operate with Big Data (i.e. a data set with many hundreds or thousands of data entries which may be interlinked/related through various relationships). Such Big Data may comprise comprehensive data relating to data related to plant health and may thus allow for Big Data analytics (which may be operated, for example, by a plantation supervisor through a computerized applications dashboard). An image processing algorithm (for example, operating using AI) may also be employed to take in captured images of plants and, based on a knowledge bank of characterized images of diseased plants, determine whether or not the plant in the captured image has, or is likely to have a particular disease, and in some examples to what extent/severity the disease is present in the plant.

In examples discussed herein, a grid approach to managing a farm or plantation may be taken. For example, overall, an entire farm or plantation may be geo mapped into multiple equal sized grid regions. If the farm is a plantation, each plant in a grid region may be geo tagged with e.g. a GPS drop pin and associated with multiple variables such as temperature, soil condition, humidity, and/or any other bespoke variables. Then an GPS intelligent map may be prepared.

The plant mapping (first level) may be made on a grid level. Using the GPS intelligent map, farm workers may, for example using a smartphone with a suitable application, scan the plants (i.e. capture images of the plants). Using the GPS intelligent map, drones equipped with cameras may map each geo tagged plant in the grid, for example. The scanned data may then be relayed to a backend server. Thus a complete set of grid data is obtained of the plantation and is available on the server. Such a server system is illustrated in FIG. 8. The AI engine employing ML may then perform “remote sensing”. That is, for example, an AI engine may be located in the backend server. The AI engine may take the grid data from the grid region as input and make multiple combinations of variables such as weather, soil condition, humidity, temperature or any bespoke variable. The AI engine can then create a ML model of the plantation, for example using an AI-based image processing algorithm to determine, from an image of a plant, whether that plant had a disease (and e.g. which disease that is, and how severe it is in the plant). Based on this ML model a GPS) intelligent map may be prepared for all other grid regions in the farm.

The plant mapping (second level) may be made on a composite grid level. Farm workers may, for example using a smartphone with a suitable application, and dictated by the GPS intelligent map, scans the plants (i.e. captured images of the plants). Facilitated and dictated by the GPS Intelligent map, drones equipped with cameras may map each geo tagged plant in the other grid regions. The scanned data is then relayed to the backend server. Thus a complete composite GRID data is prepared on the server.

The ML engine may then perform the “risk mitigation” phase. The AI engine may take the composite grid data (of the entire planation or farm) and make the differentiation of the individual grids up to individual plants. It may create a library of plant images. The AI engine may also have default library of a specific plant disease images and the lifecycle of the diseases. By comparing the default library with real time images it may be able to identify, for example: plants that are infected; and plants that may get infected. Accordingly, a GPS intelligent map may be created for each grip region using the plant geo tagging data.

Next, targeted spraying of the identified plants may take place. Field workers may, for example using a smartphone with a suitable application, and dictated by the GPS intelligent map, perform targeted spraying of the specific plants. Facilitated and dictated by the GPS Intelligent map, drones equipped with treatment substance tanks (e.g. insecticide dispensers) may perform the targeted spraying of the specific geo tagged plant in the other grid. The spray data may be relayed to backend server.

The above steps may be repeated, for example daily, to improve and tailor the data on the plantation and its development with time and treatment. In a “remote sensing” phase, the ML engine may again prepare an updated GPS intelligent map (with individual plant geo tagging) for each grid. The drones are fed/input with the updated GPS intelligent map. The drones may then hover on the designated plant (and in some cases may capture a 360° view), using a fitted camera to scan the specific diseased/infected part of the plant. Image processing algorithms to identify disease in the plant may operate in real-time or near real-time to determine the presence of a particular disease or diseases, at what severity, and which portions of the plant are affected, as the drone scans and captures images of the plant. The AI and ML engines can work in tandem to analyze the effect of targeted spraying. Another overlay of the GPS intelligent map may thus be prepared with an updated status of each plant (geotagged) for each grid region, and for all the grid regions (in a composite grid) and then, for example, high risk plants may be flagged. For risk mitigation, the latest GPS intelligent map with high risk plants may be fed to a drone, which can carry out simultaneous scanning and targeted spraying, for example. In some examples, a drone may be fitted with a 1 kg to 5 kg load of treatment substance (e.g. pesticide) for application to affected plants.

Information may be displayed to a user, for example, a field worker operating a smartphone or a farm supervisor at a desktop or laptop computer. A big data dashboard may be provided at the user level back end, and may visually depict the entire farm/plantation, for example in a colour coded manner (e.g. green for a healthy plant, orange for a treated plan to be monitored, and red for a plant requiring treatment). Such information may be updated in real time and/or may provide historical references.

With every repeat/iteration the AI and ML models of the plantation being monitored become progressively more robust, leading to a high degree of accuracy in plant disease prediction. As the system becomes more accurate through repeated iterations, it may be that (up to) the entire operation of plant treatment of the farm will be executed by drones, allowing for field workers to be redeployed, to better value-added farm assignments.

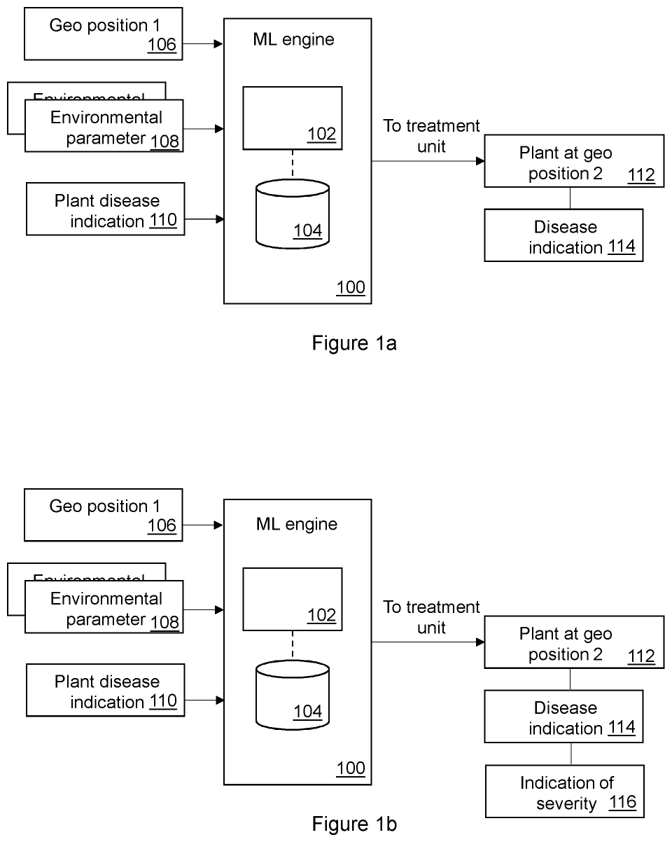

FIGS. 1a-1b show examples of computer apparatus 100 which operate a ML engine to receive field data 106, 108, 110 for a diseased plant and predict other plants 112 which also require treating for that disease, according to examples disclosed herein. The apparatus 100 comprises a processor 102, a memory 104 coupled to the processor 102, and computer-readable instructions stored on the memory 104. The instructions cause the apparatus 100 to perform certain functions (but the apparatus may also provide other functionality to that described here).

The apparatus 100 receives data captured from a first geo position of a plant in a crop plantation. This may be received over a communications channel from a worker in the plantation, from a sensor operating in the plantation, or from a drone operating over the plantation, for example. This plant may be referred to as the first plant, or as a reference plant, since it may be used as a reference in the field of a plant from which a prediction of plant disease of other (second) plants may be obtained.

The data indicates the first geo position 106; that is, the location of a first plant in the plantation. The geo position may be obtained via GPS tracking of a device in the field at the first location in some examples. The geo position may be obtained in some examples by using a look up table or database, by matching a received unique identifier of the plant to the geo location logged and recorded for that plant. The data indicates at least one environmental variable 108 at the first geo position. The environmental variable(s) indicate one or more of: temperature, humidity, rainfall, soil condition and dewpoint at the plant location. For example, either stationed in the plantation, or part of a portable device transported around the plantation, such environmental variables may be sensed by a suitable sensor, such as a thermometer (to measure temperature), hygrometer (to measure humidity), a rainfall sensor, soil nutrient/constituent monitor, and a dewpoint sensor. Other environmental parameters may be sensed and provided to the apparatus 100, such as wind speed, wind direction, air pressure, cloud cover, brightness, ice presence etc.

The data provided to the apparatus 100 also indicates an indication of a plant disease 110 of a first plant at the first geo position. For example, a field worker or a drone may log that a disease is present (and in some examples, what that disease is, and in some examples, how severe the disease extent is) on the first plant. By noting that a disease is present in a first plant (and in some examples, what the disease is and/or how severe the extend of infection is), this information allows the ML engine 100 to determine the likelihood of that disease being present in other plants in the plantation (and, in some examples, how severe the disease is likely to be or become). There may be more than one disease present and all diseases may be provided to the apparatus 100. In some examples, a finding of “no disease” may also be provided to the apparatus 100. A plant disease may be, for example, an insect infestation, fungus, lack of nutrients, lack of viable growth environment, or other cause of detrimental growth or yield of the plant. In some examples, a user may visually identify a disease and log that disease. In some examples, the user may provide an image or video of the plant for remote analysis to determine what the disease is, for example through another expert user analysis station outside the plantation field, or through AI recognition (discussed below).

The apparatus 100 then uses a machine-learning, ML, model, to predict a likelihood of the disease 110 being present in a second plant at a second geo position (which is different to the first geo position) in a predetermined timeframe. The prediction is made based on several factors which may be interrelated. The received data (geo position environmental parameter(s) and disease indication) from the first plant is used, as well as a first historical record and historical environmental variable values of the first geo position. The first historical record indicates, for example, previous plant diseases, treatment of previous plant diseases, and/or historical environmental variable values from: temperature, humidity, rainfall, soil condition and dewpoint, of the first plant. In other words, the history of the first plant is considered in predicting a second plant which may be affected. The first environmental variable indicates the local environment and surroundings at the first geo position. For example, the first environmental variable may indicate, for example, soil quality, altitude, slope, permanent shade (e.g. from nearly landscape), and whether a treatment has been previously applied in that location (and if so, which treatment, in what concentration/quantity, and how often). The first plant in the crop plantation may have an associated unique identifier. In some examples the apparatus 100 may retrieve the first historical record and/or the first environmental variable from a database of historical records and a database of environmental variables using the unique identifier.

Also considered are factors relating to the second plant predicted to be diseased (and plural possible second plants may be considered before a most likely (or plural most likely) candidate second plant to be diseased is identified). These factors comprise a second historical record of a second geo position, as before for the first geo position, indicating, for example, previous plant disease, treatment of previous plant disease, and/or historical environmental variable values from: temperature, humidity, rainfall, soil condition and dewpoint. These second plant factors also comprise a second environmental variable, similarly to the first environmental variable, indicating the local environment of the second geo position.

As a very basic example, if a plant in a first portion of a plantation is infected with Sigatoka, and that portion of the plantation has experienced a particular rainfall, the ML model may predict that a second plant in a different portion of the plantation with similar environmental parameters to the first plant, which has had a similar rainfall, is also likely to be infected with Sigatoka and should be treated with an anti-Sigatoka treatment substance. Of course the possible permutations of variables data and the effect which each parameter has on the likelihood of a second plant being diseased, as well as accounting for the historical environment and treatment of the plantation, may lead to a vast number of possible outcomes, which is where using a machine learning system can help to provide an evidence based prediction of disease likelihood across the plantation.

By predicting the likelihood of the disease being present in a second plant at a second geo position (that is, by predicting the likely location of disease spread in the plantation/farm), by considering combining and/or permutating various factors such as the weather, temperature, soil condition and/or any other bespoke variables, and how they are known to have previously affected the spread of disease in infected plants and potentially infected plants (through considering the received and environmental data on the first plant and a historical record of the first plant, and considering the historical and environmental data of the second plant being considered as a candidate plant to be diseased), an accurate and dynamic prediction of disease spread may be obtained.

The ML model in some examples may be configured to use Bayesian probability analysis to predict the likelihood of the disease being present in the second plant in the predetermined timeframe. This is discussed in more detail in relation to FIG. 3.

The apparatus 100 is then configured to provide, following ML analysis of the input data, a disease indicator 114 of the likelihood of the disease being present in the second plant 112 to a treatment unit. The disease indicator is configured to cause treatment of the second plant 112 at the second geo location by the treatment unit according to the predicted likelihood of disease 114, to reduce the likelihood of the disease occurring at the second plant. For example, the treatment unit may be a drone fitted with a plant treatment substance sprayer/applicator, and the indication of a second plant to be treated may be provided to the drone which can then visit the area likely to be affected, and treat it. In another example the treatment unit may be a handheld communication device carries by a field worker, who can visit the indicated second geo location and treat the indicated plant. The disease indicator may indicate the second geo location of the second plant in some examples. In other examples, the second geo location may be indicated in a separate data field.

The disease indicator may, in some examples, also provide an indication of what the disease type is which is predicted to be present, a plant location to treat on the second plant; and/or an indication of the particular treatment to use (e.g. which treatment substance to use, a volume of treatment substance to apply, a concentration of treatment substance to apply, a treatment schedule indicating when to treat the second plant), as determined by the ML model based on previous treatments of plants in comparable situations and which were found to be effective.

By indicating the likelihood of the disease being present in a different location, targeted treatment of the plantation may be effected where it is needed, and treatment may be avoided where it is unlikely to be required. For example, a map may be generated of a farm or plantation, indicating GPS locations where disease treatment should be made. Such a map may represent a portion of a farm/plantation (e.g. a grid square of a whole farm/plantation divided by gridlines into a plurality of grid squares), or may represent an entire farm/plantation. Areas identified for treatment may be indicated on the map by GPS drop pins. The targeted areas may then be treated, for example by farm workers (staff) and/or automatically by drones which can travel to an indicated area and apply a treatment substance. In examples where locations are indicated by GPS locations, an entire farm or plantation may be divided into individual grip regions using GPS mapping. Each plant in a plantation mapped in this way may be identified and tagged with a GPS geo location identifier (and, for example, located (and may be displayed) on a map using the GPS geo location identifier.

In examples where a grid map is generated of a planted area with e.g. drop pins indicating plant locations of plants likely to require treatment, a field worker and/or drone may scan (manually/visually, and/or computationally) the grid to identify the locations of plants requiring treatment. Computationally scanning the map may be performed in some examples using a dedicated application. For example, a field worker may capture images of first plants from a plantation using a smartphone camera in communication with the ML device, and may receive GPS results from the ML apparatus indicating plant positions where treatment is likely to be required which is displayed on the smartphone display. For example, a drone may be able to scan a plant, and/or each part of (e.g. each fruit, each leaf) a specific plant indicated on the grid and the scanned plant may be identified using GPS. This may be considered to be remote sensing, whereby images of plants are obtained without requiring a human to physical visit the plant. Thus in some examples, the input data to the ML device may comprise a) geo location data of plants (for example, as obtained from a GPS drop pin collage representing each plant in the plantation or plantation portion/grid section), b) plant disease parameters such as plant history at the GPS locations, and c) real time imagery of (e.g. all) the plants present in the designated grid section.

The apparatus 100 in some examples, as shown in FIG. 1b, may be configured to use the trained ML model to predict a likely severity of the disease predicted to be present at the second plant; and provide a severity indication 116 of the predicted likely severity of the disease being present to the treatment unit, the severity indication 116 to cause treatment of the second crop at the second geo location according to the determined likely severity of the disease. That is, the likely severity of the disease may be predicted and may be used to determine a more appropriate treatment (e.g. concentration of substance to apply, schedule for treatment, or even to remove the diseased plant from the plantation).

It will be appreciated that the computerised determination of a second plant to be treated advantageously allows for a comprehensive analysis of relevant factors in predicting where a disease is likely to arise in the plantation and in some examples, providing an indication of a most suitable treatment to apply to the second plant. In examples where a plantation is very large (several hectares), it is not possible for timely human analysis of all plants to determine is a disease is present as there are too many plants to assess. Further, it is not possible or practical for a human to consider all possible relevant factors and predict where a disease may arise next, but such predictions may be more confidently made via the ML models discussed herein.

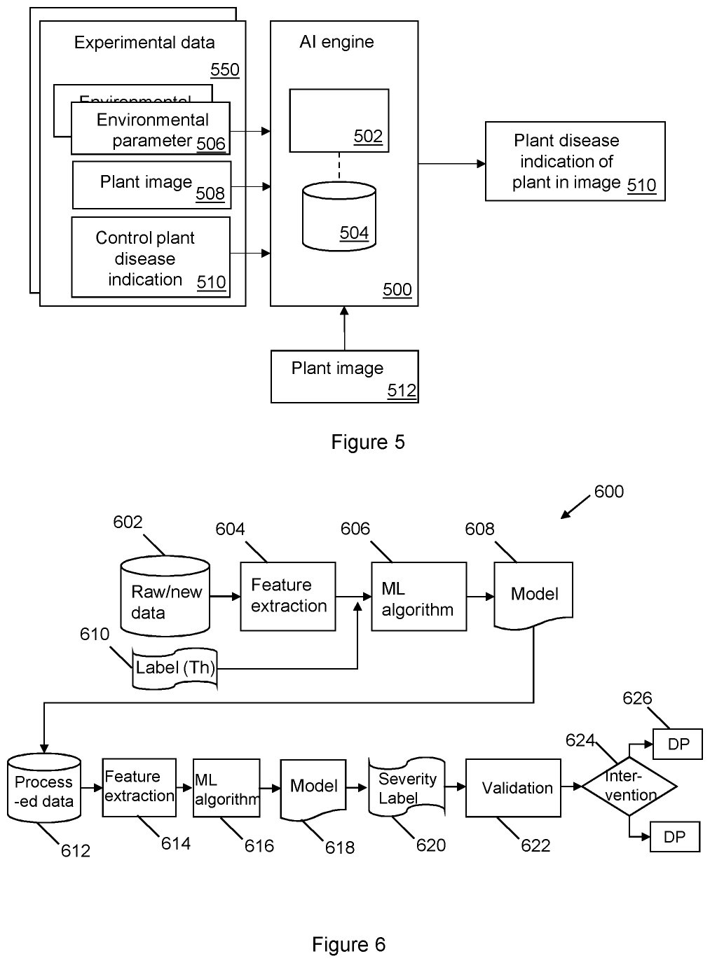

The indication of the plant disease of an inspected plant may be obtained/determined from an artificial intelligence, AI, model, which is described in more detail with reference to FIG. 5. The AI model may be trained using experimental control data indicating, for each control plant of a plurality of control plants, an image of the control plant, one or more plant diseases or plant disease absence of the control plant, and a plurality of environmental parameters of the control plant. The plurality of control plants may have similar characteristics to the first plant, such as being the same species, the same batch of crops, the same fruit or grain yield, and/or the same age, for example.

The trained AI model, once it receives a captured image of the first plant as input, may then determine an indication of the plant disease for the plant in the captured image based on the training data. For example, the AI model may have access to many images of plant leaves which are infected with different diseases to different extents. When a new image of an infected plant leaf is provided to the AI model, an indication of the disease and the severity of the disease may be determined based on the training data images and information on the diseases shown therein. In many cases, an AI trained model trained with many (e.g. hundreds or thousands) of images is able to identify a disease and the severity of the disease (and if so trained, suggest a suitable treatment which has previously been effective in treating that particular disease) more accurately, more objectively, and more quickly than a human (e.g. plantation manager) who is trained as an expert disease identifier.

In some examples, the identification of diseased plants may use human observation and expertise to spot plants which are affected by disease. In such examples, at different points in time, such as periodically (e.g. daily), field workers (“spotters”) may observe the health of plants in the field to identify disease occurrence. The field worker may then report the disease occurrence to a central reporting device. For example, the field worker may have a camera-equipped communication device, such as a smartphone, and may capture an image of the diseased plant which is transmitted for central reporting. The field worker may have a communication device by which an indication of the disease may be selected from a drop down list, or similar, and this indication is then transmitted for central reporting. The location of the diseased plant is also transmitted with the disease information. This may be obtained, for example, through GPS location. In some examples, each plant may be physically tagged/labelled with a unique identifier (for example, an alphanumeric code, barcode, or OR code) and this label may, in some examples, also include the geolocation of that plant. The field worker's device may be configured to store the plant information locally (on the worker's device) or on a local server, in the event that there is insufficient communication network available, for subsequent central reporting when there is sufficient communication network available for information transmission.

In some examples, the identification of diseased plants may be a trained AI engine to receive plant information from a field worker and analyse the information to determine the presence (and in some examples, the severity) of one or more diseased plants.

This identification may then be sent for central reporting. The field worker may also receive a report of an AI recognised disease, for example so the field worker can treat that plant while they are at that location. The AI engine is discussed in more detail in relation to FIG. 5.

In analysing a plant, the analysis may be performed at different granularities, and which granularity is used may depend on the particular disease being logged. For example, in a banana plant, if BLS is suspected or identified, then the disease assessment may be made and reported leaf-by-leaf. In such leaf-by-leaf examples, a leaf count of diseased leaves to non-diseased leaves may be used to determine a severity of that disease in that plant. In another example, in a banana plant, if BBT© is suspected, then the plant may be analysed as a whole plant, and may be reported for eradication if the extent of the disease is considered severe enough.

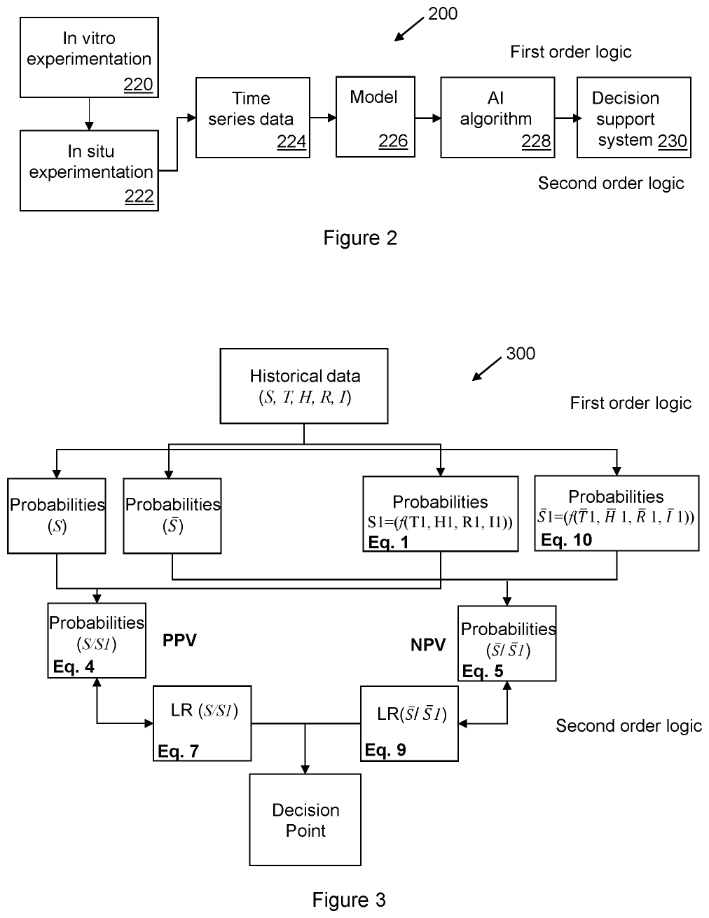

FIG. 2 illustrates a logic process 200 of training the ML engine to predict diseases in a plant based on determining relationships between different parameters from experimental input data. The term “training” may be taken to mean “curated and calibrated”. The training data used to train the ML model is data may be considered to be “curated” (i.e. has been selected and provided as training data from the available data using professional knowledge) from the initial experimental data (by the experimental scientists (and once running, includes data which is recorded from the field/plantation workers and/or their supervisors). Thus the term “training” are related terms (e.g. “training data” and “training phase” may be considered to relate to curating data for use in establishing the ML model). The data may be considered to be “calibrated” in some examples because the initially obtained training (curated) data has been built upon by additional data obtained from the field, and as such, the original lab-based or controlled training data is supplemented with real-world field data to calibrate the ML model to apply more closely to the actual plantation for which is it used to predict plants requiring treatment. Thus the steps of providing data on a first plant from the field on which to base a prediction of a further plant which is also likely to require treatment may be considered to be “calibration” of the ML model. The data may be considered to be “calibrated” in some examples because it has been input to the ML model in a format (e.g. scaled/normalised, converted into suitable units, averaged as required by the model) so that it is meaningful for inclusion in the ML model.

In a test case study, in vitro experimentation 220 was performed to determine the behaviour of the pathogens Black Sigatoka (Mycosphaerella fijiensis) and Bunchy top aphid carrier Pentalonia nigronervosa. In addition, greenhouse experiments 222 were conducted to determine the spread of the diseases in plants. These experiments 220, 222 provide time series data 224 (i.e. indicating disease development as a function of time) which may be analysed. Using Propositional Logic, Experimental Learning Laboratory with Animation (STELLA), the green house results were modelled 226 to determine relationships between environmental parameters and their relationships to the disease growth and spread as derived based on real-time onsite data set, From this an AI algorithm 228 is obtained which provides the ML model 228 for use in disease prediction® this may be termed a “decision support system” 230 to assist in making a decision where to apply treatments to plants to mitigate against disease.

An example first order Artificial Intelligence framework as used in this test case study is:

(∀A)([∃w)(w∈A)\hat{ }(∃u)(∀u)(u∈A→u≤z)]→(∃x)(∀y)[(∀w)(w∈A→w≤y)↔(x≤y)])

The second order AI framework in this test case study is then:

∀ₓ∀_{y}(P(f(x))→¬(P(x)→Q(f(y),x,z)))

To test and validate this result, a test was carried out in situ by applying the first order AI to a 12-hectare banana plantation. In this experiment, four experimental treatments were considered based on level of severity or infestation and were categorized as follows:
a) Treatment 1-3% severity level (SL);
b) Treatment 2-5% SL;
c) Treatment 3-10% SL; and
d) Treatment 4-12% SL.

These severity levels were observed daily for 180 days. Moreover, environmental sensors were planted across the experimental site to collect data on humidity, rainfall, dewpoint, and temperature. These data are recorded every 15 minutes, but for purposes of model development a 24-hour average was considered in the computation. For disease interventions applying the second order AI applied to ensure regardless of the treatment, productivity is not affected. With this application data on factors of productivity were also analysed. These factors are as follows: Net Fruit Weight; Fruit Calibration (in mm); Age of harvest (weeks); Number of hands; Number of leaves during harvest; Quantity of Class A (in kgs); Quantity of Class B (in kgs), Quantity of rejects (in kgs); Cost of spraying.

Results showed that except from the cost of spraying, all factors showed no significant statistical difference among treatments. This was understood to mean that the timing of disease intervention will not significantly affect productivity. However, this study found that cost, and frequency of spraying, does significantly differ among treatments as shown in the Table below.

TABLE 1
Cost and Frequency of Spraying in Number of Spraying per month

| Variable | Treatment | Mean (cycle) | p-Value |
|---|---|---|---|
| Frequency of | T1 | 4.0000 | 0.18 |
| Spraying (M1) | T2 | 3.3333 | |
| | T3 | 1.6667 | |
| | T4 | 1.0000 | |
| Frequency of | T1 | 7.686.1 | 0.001 |
| Spraying (M2) | T2 | 6.595.5 | |
| | T3 | 1736.8 | |
| | T4 | 3079.7 | |
| Cost of Spraying 1 | T1 | 7.686.1 | 0.21 |
| | T2 | 6.595.5 | |
| | T3 | 1736.8 | |
| | T4 | 3079.7 | |
| Cost of Spraying 2 | T1 | 10091.0 | 0.39 |
| | T2 | 7990.7 | |
| | T3 | 5878.8 | |
| | T4 | 3111.7 | |

These real time experimental results were used as initial training data to train a dynamic Machine Learning (ML) model, which was developed to predict future severity of the disease. The ML model was then coded and was able provide predictions of future instances of disease in the banana plants up to 7 days in advance. The ML model is linear and comprises a combination of multiple decision outcomes, thereby combining ten mutually exclusive ML equations. The process flow followed to arrive at a ML model as discussed herein is illustrated in FIG. 3.

The Machine learning framework may be represented as;

γ=C+αT+βH+δR+θI+ε (ML Equation 1)

where:
γ is the severity level of disease (as a percentage)
C is a constant
T is the 24-hour temperature in degrees centigrade
His the 24-hour humidity
R is the 24-hour rainfall
I represents whether or not there is an intervention (i.e. dummy variable, 0 if no intervention, 1 if there is an intervention)

α,β,δ,θ are coefficients, and
ε is the error term

The treatment selected for modelling was based on the cost, frequency of spraying and the amount of disease inoculum. For this study, Treatment 3 (10%) severity level was chosen as the best option although it is not the least costly and frequent. Although Treatment 4 (12%) severity level is a likely candidate, the inoculum level is high, which would result in a higher infestation.

Using the second order AI logic, the model derived is shown below:

Y=−40.07038+0.83709T(t−5)+0.29744H(t−5)+0.06445R(t−5)−1.84247I(t−1)

p-value (0.007) (0.004) (0.002) (0.028) (0.13)

(Note: the numerical coefficients of this model changes when new data are received by the system)

In order to determine the appropriateness of the model, the initial iterations in model generation were compared with the results in the in vitro experiment 220. This comparison was done in order to determine the lag in the effect of the parameters (temperature, humidity, rainfall and intervention). In the process of deriving the appropriate lag, the literature was reviewed to validate the results using different lag values. For this study, significant results were found five days after a given event was observed and were found to positively and significantly affect disease severity levels—except for the intervention (I) that has a negative effect, which is expected because disease spread is halted.

A further consideration was to use Bayes' Theorem in predicting the occurrence and non-occurrence of Sigatoka (Mycosphaerella fijiensis) disease in bananas at 10% severity level based on prior experiments. For this S represents the occurrence of Sigatoka without reference to the threshold level, thus the unconditional probability of Pr(S) is the unconditional probability of Sigatoka occurrence. This means Pr(S) represents the prior probability based on the historical from field observations. The inverse then is Pr(Ŝ) which denotes the probability of non-occurrence such that:

Pr(S)+Pr(\hat{S})=1 (ML Equation 2)

S1 represents the prediction (using equation 1) of the Sigatoka occurrence and Ŝ1 represent the prediction of Sigatoka non-occurrence. Then similarly:

Pr(S1)+Pr(\hat{S}1)=1 (ML Equation 3)

Thus, the sensitivity is computed (true positive rate) or the conditional probability using the expression Pr (S/S1). This means the probability of Sigatoka occurrence given that the disease actually occurred. For computing the specificity (true negative rate) the conditional probability can be expressed as Pr (Ŝ/Ŝ1). On the other hand, the false negative rate can be expressed as Pr (Ŝ1/S) while the false positive rate can be expressed as Pr (S1/Ŝ). These expressions represent the properties characterizing the predictors extent to which occurrence and non-occurrence of Sigatoka is indicated. For practicality, conditional probabilities such as Pr (S/S1) were applied in computing the positive predictive value (PPV) and Pr (Ŝ/Ŝ1) in determining the negative predictive value (NPV), expressing the PPV and NPV as:

$$Pr ( S / {S}_{1} ) = \frac{Pr ( \frac{S 1}{S} ) Pr ( S )}{Pr ( \frac{S 1}{S} ) Pr ( S ) + Pr ( \frac{S 1}{S} ) Pr ( \hat{S} )} \qquad ( ML Equation 4 )$$

$$Pr ( \hat{S} / {\hat{S}}_{1} ) = \frac{Pr ( \frac{\hat{S} 1}{S} ) Pr ( \hat{S} )}{Pr ( \frac{\hat{S} 1}{S} ) Pr ( \hat{S} ) + Pr ( \hat{S} 1 / S ) Pr ( S )} \qquad ( ML Equation 5 )$$

Using equations 4 and 5, it is now possible to compute for the likelihood ratio (LR) make predictions about the likelihood of disease occurring. For PPV, LR (S/S1) can be expressed as:

$$L R ( S / {S}_{1} ) = \frac{Pr ( S 1 / S )}{1 - Pr ( \frac{\hat{S} 1}{S} )} \qquad ( ML Equation 6 )$$

$$LR ( S / {\hat{S}}_{1} ) = \frac{Sensitivity}{1 - Specificity} \qquad ( ML Equation 7 )$$

Equally, for NPV, has been computed as:

$$LR ( S / {S}_{1} ) = \frac{1 - Pr ( S 1 / S )}{Pr ( \frac{\hat{S} 1}{S} )} \qquad ( ML Equation 8 )$$

$$or$$

$$LR ( S / {\hat{S}}_{1} ) = \frac{1 - Sensitivity}{Specificity} \qquad ( ML Equation 9 )$$

Equation 8 illustrates the effect of prediction of Sigatoka occurrence is to increase the later events of Sigatoka occurrence relative to prior events, while equation 9, illustrates the effect of prediction of Sigatoka occurrence to decrease the later events relative to prior events. Thus, the results may be analysed by looking at large LR (S/S1) and small LR (S/Ŝ1).

However, from equation 1, S1 is a function of Temperature (T), Humidity (H), Rainfall (R) and Intervention (I). Thus, there is a need to compute for the probabilities of these parameters to determine the value of S1.

Thus, in computing deriving values of Pr (S1), this can be expressed as;

$$Pr ( {S}_{1} ) = γ = C + α Pr ( \frac{T}{T 1} ) + β P r ( \frac{H}{H 1} ) + δ Pr ( \frac{R}{R 1} ) + θ P r ( \frac{I}{I 1} ) + ε \qquad ( ML Equation 10 )$$

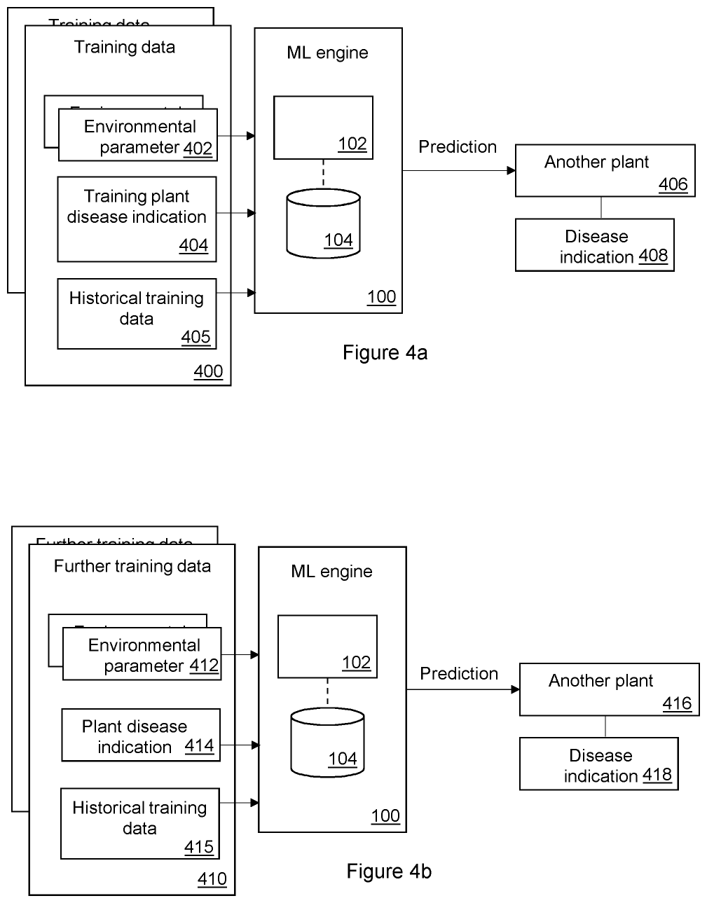

FIGS. 4a and 4b show schematic examples of initial (FIG. 4a) and feedback (FIG. 4b) training of a computer apparatus 100 which operates a ML model with data 400, 410 on disease in plants, to allow for the ML model to predict future disease in other plants 406, 416, by indicating the input data 400, 410 provided to train the ML model. FIG. 4a shows initial training of the ML model 100 using training data, for example, data obtained through controlled experiments and/or data collected from the field and verified as reliable. Training the ML model 100 may be performed according to an initial training phase comprising receiving a series of training data entries 400. Each training data entry may indicate, for a training plant, at least one environmental parameter 402 from: temperature, humidity, rainfall, soil condition and dewpoint; an indication of a training plant disease 404; and a training historical record 405 indicating one or more of: previous training plant disease, treatment of previous training plant disease, and historical training plant environmental variable values from: temperature, humidity, rainfall, soil condition and dewpoint. The ML model then, as discussed above in relation to FIGS. 2 and 3 for example, may determine relationships between the training data entries to allow for prediction of the likelihood of the plant disease 408 for another plant 406.

FIG. 4b shows further training of the ML model 100 using field-collected data, for example, from day to day data collected during work in the plantations. This training may be considered to be a top up on the initial training shown in FIG. 4a. By further training the ML model with data obtained in an ongoing way from the plantation being worked on, the model adjusts its output to be a better model for the plantation. In other words, the training process of the ML model is repeatedly iterated progressively, thus dynamically recalibrating the ML model to provide high degree of relevance and accuracy.

Further training the ML model may thus be performed according to a feedback training phase as illustrated in FIG. 4b, comprising: receiving a further data entry 410 indicating, for the first plant: the first geo position; the at least one environmental variable 412 at the first geo position from: temperature, humidity, rainfall, soil condition and dewpoint; the indication of a plant disease 414, and a first historical record 415 of the first geo position indicating one or more of: previous first plant disease, treatment of previous first plant disease, and historical first plant environmental variable values from: temperature, humidity, rainfall, soil condition and dewpoint. The ML model then determines relationships between the training data entries and the further data entry to allow for prediction of the likelihood of the plant disease 418 for another plant 416. In some examples, the plants in the crop plantation may each have an associated unique identifier. In some examples, the apparatus 100 may store data such as the at least one environmental variable, and the indication of a plant disease of the first plant at the first geo position, with the unique identifier, for subsequent use as training data to train the ML model.

In some examples, a lag, or time difference, between changing a parameter and a change occurring in the state of the disease may occur. For example, a disease may not begin to die away until a time (e.g. 48 hours) after a treatment has been applied to treat the disease. As another example, a disease may be likely under humid conditions, but may not start to be visible until a time after the humid conditions have started, for example seven days. Thus, to account for lag times in disease development and treatment, training the ML model 100 may comprise: comparing the prediction of the likelihood of the plant disease 408 obtained in the initial training phase of the ML model with the experimental control data 220, 222 indicating one or more plant diseases or plant disease absence of a control plant, to determine a lag time between the effect of changing a parameter of the set of environmental parameters and a resultant effect on the plant disease. Then, the determined lag time may be used as input 410 to the ML model 100 for the compared prediction and experimental control data to train the ML model to determine a relationship between a change in an environmental parameter and determined lag time.

FIG. 5 shows an example of a computer apparatus 500 which operates an AI recognition engine which is trained with experimental data 550 indicating diseases in plants and the effect of environmental factors to identify disease in other plants. In some cases, a disease may be visually present for a human to see, and a trained field worker may be able to identify from looking at the plant which disease it has, and the severity or extent of the disease in the plant. However, this method of plant disease identification is subject to human error, and some diseases or early stages of some diseases cannot be easily seen or recognised by the human eye. Further, if the disease is only present on the top of a plant which is above head height, a human observer will not be able to see the disease on the plant. A remote camera, such as a drone-mounted camera, may be able to capture an image of the top of the plant but cannot alone make any determination about what is shown in the image. Therefore, it may be beneficial to have a computer implemented method of disease recognition from images, both for images which are not seen by a human and for diseases which are difficult to identify by a human. This AI engine 500 may be considered to be an expert knowledge bank in some examples allowing for accurate, and computer-automated, disease recognition of an imaged plant.

FIG. 5 shows a disease recognition apparatus 500 (which may be termed an AI engine) comprising: a processor 502; a memory 504 coupled to the processor 502. Computer-readable instructions stored on the memory 504 which, when run on the processor 502, cause the apparatus to receive, as training input, control data 550 from a control plant in experimental control conditions. The control data 550 indicates an image of the control plant 508, a disease of the control plant 510 in an environment having a set of environmental parameters, and data representing the set of environmental parameters 506. The apparatus 500 may then establish, from the received training input 550, a knowledge library of plant diseases 510 according to plant appearance 508 and environmental parameters 506. This apparatus may then be used as an image recognition apparatus to automatically detect, for example, the presence of a disease in an image of a plant (e.g. captured by a drone), which disease it is, which portion(s) of the plant are affected, and/or the severity of the disease, all of which may feed into the ML model for determination of an appropriate treatment of that (and in some examples, neighbouring) plants.

Subsequently the apparatus 500 may receive, as use input, a captured image 512 of a crop plantation plant. A field worker may have captured the image on a smartphone, or a drone may have captured the image from above the plantation. The apparatus 500 may determine, based on the received captured image 512 and the knowledge library, a disease of the crop plantation plant; and provide, as output, an indication of the crop plantation plant disease 510 in the captured image. In this way, the recognition of a disease is computerised, allowing for improved accuracy of disease recognition, recognition of diseases from regions of plants which are not accessible to humans, and allowing for a higher level of automation of disease management in the plantation by removing the requirement for skilled human disease “spotters”. Further, as images of plants are captured during day-to-day operation of the plantation and as images are captured and fed into the AI system for analysis and disease recognition, these images may also form a part of the data held in the knowledge bank which further refined the AI model to improve disease determination in future plants, in a way which is tailored to that particular plantation. In this way the image recognition system increases in accuracy with use.

FIG. 6 indicates an overall combined process 600 of training a ML model to recognise where disease may be likely, and using the trained ML model to predict the disease occurring in another plant. In the first step 602, raw and new ML training data is cleaned and fed into a feature extraction module 604 to select useful features from all available features. For example, photographs of diseased plants 602 may be analysed to extract the features of those photographs which indicate the disease, or regular temperature readings may be averaged over a day, for example. Next, labels 610 of the features, and the extracted features, are passed to the training phase 606, where ML algorithms (linear and probability models) are used to identify a good model 608 which maps inputs (i.e. a photograph of a first plant with a disease) to desired outputs (i.e. a prediction of a second different plant which is likely to develop that disease).

The next phase involves the ML prediction process, which may employ a Bayesian algorithm to determine the likelihood of disease occurrence. The processed data 612 from the trained model is used by a feature extraction module 614 to select useful features from all available features of an input plant. The extracted features are passed to the ML prediction algorithm 616 and used to determine a prediction model 618 of where other plants are likely to require treatment. A severity label 620 is applied in this example to indicate the predicted severity of disease at the predicted plant. The prediction then goes to validation 622 (for example, a worker or camera-equipped drone visits the predicted plant site to verify that there is indeed a need to treat that plant for disease) and once validated, a decision is made whether to intervene 624 and treat the predicted plant at a “treat” decision point, 626, or whether the predicted plant should not be treated.

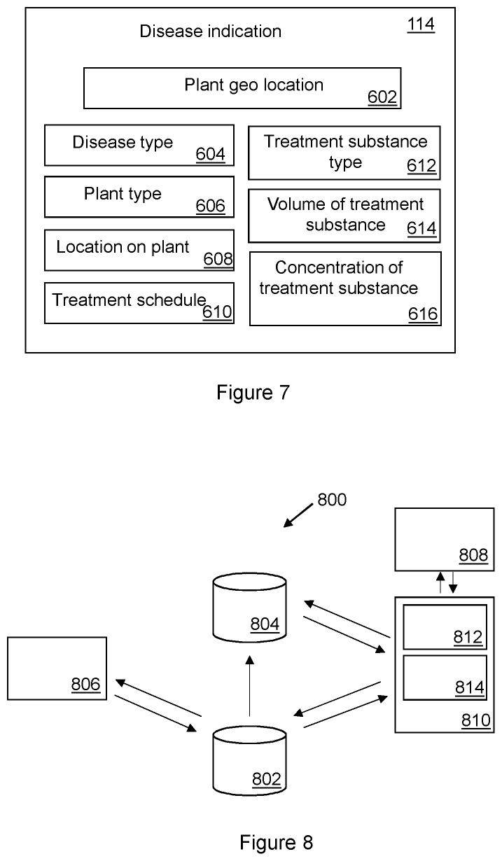

FIG. 7 shows schematically an example data record of a disease indication 114. The disease indicator 114 may indicate: the second geo location of the second plant 602; and/or one or more treatment parameters from: the disease type 604, the treatment substance type 612, the plant type 606, a volume of treatment substance to apply 614, a concentration of treatment substance to apply 616, a plant location to treat on the second plant 608; and a treatment schedule indicating when to treat the second plant 610. Such treatment parameters may be generated by the ML model 100 from training data indicating, for previous disease occurrence in previous plants, which treatments are effective and which are not effective. Other disease indicators (e.g. affected leaf count, presence of live insects, stunted plant growth factor, etc.) may be present in other examples.

FIG. 8 shows an example computing network 800 for receiving data on diseased plants and providing data to a treatment unit to treat other plants for the disease. The computing device network 800 comprises any apparatus 810, 812 disclosed herein configured to provide a disease indicator of the likelihood of the disease being present in the second plant to a treatment unit, such as the ML engine illustrated in FIGS. 1a-1b, and 4a-4b. The network 800 in this example comprises a treatment unit 808 configured to receive the disease indicator. This may be a drone or a field worker communication device, for example. A treatment unit 808 comprising a drone may be configured to: receive the disease indicator comprising a geo location of the second plant and a treatment to apply to the second plant; travel to the second plant at the geo location; and apply the treatment indicated in the disease indicator to the plant.

The network 800 in this example also comprises any disease recognition apparatus 810, 814 disclosed herein configured to provide an indication of the crop plantation plant disease, such as the AI engine 500 of FIG. 5, although in other examples other (e.g. human) disease identification may be used. In this example, both the ML engine 812 and the AI disease recognition apparatus 814 are shown as being part of the same computing apparatus, but in other examples they may be separate, connected apparatuses.

The device network 800 in this example also comprises a field device 806, such as a workers' smartphone. The field device 806 may be configured in some examples to capture and transmit the geo position and the at least one environmental parameter at the geo position data in the crop plantation to any apparatus 810, 812 described herein. The field device 806 may be configured in some examples to capture and transmit, as use input, the captured image of the crop plantation plant to any disease recognition apparatus 810, 814 disclosed herein.

The device network 800 in this example also comprises a storage server 802, 804 in communicative connection with any apparatus 806, 810 disclosed herein, and any disease recognition apparatus 814 disclosed herein. The storage server 802, 804 may be configured to store one or more of the transmitted captured data from the geo position in the crop plantation; and training data used to train the AI model. In some examples, as shown here, the storage server may be distributed, for example to provide remote backup and/or to store different data types separately for data management.

The different components of the device network 800 may be used together from the field on site/real time, to collect, to curate, and to automatically analyse the collected data, generating visualization of existing and potential up-coming disease hotspots and indicating them via geo positional indications. Such systems allow for automated deployment of field resources and/or drones with treatment equipment to effectively mitigate the risk of diseases spreading in the plantation.

In some examples, the second geo location which are predicted to require treatment against disease may be indicated in a graphical display of a map of the plantation of portion of the plantation which requires treatment. For example, on a map display of the plantation, a GPS pin or marker may be displayed on the map where treatment should be applied. It will be appreciated that other information may also be provided in the graphical display, such as the plant identifier, plant type, treatment to be applied (e.g. substance, concentration, schedule of application etc.), and/or whether a plant has been assessed and/or treated, for example.

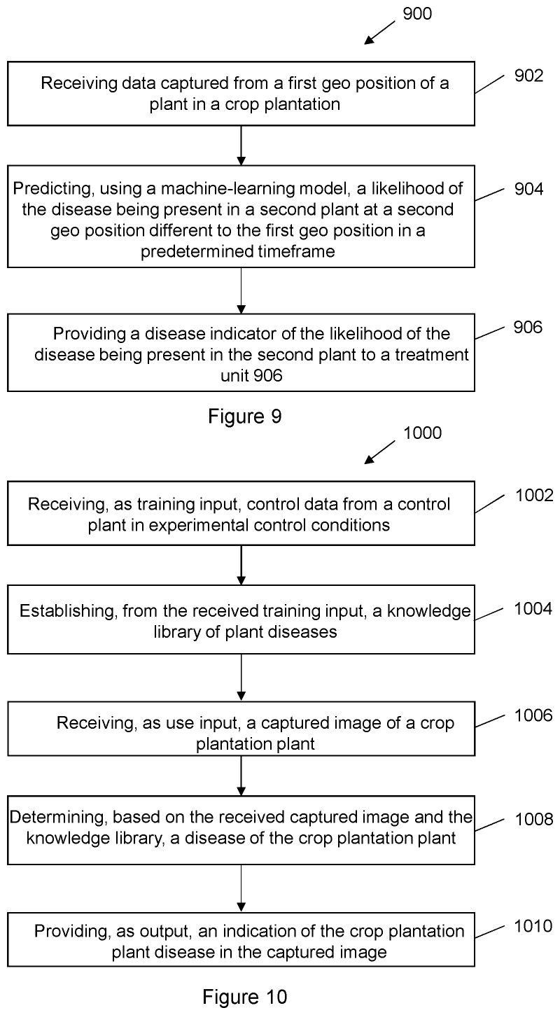

FIGS. 9 and 10 show example methods according to examples disclosed herein.

The computer-implemented method 900, for obtaining an indication of where to treat plants for disease, comprises receiving data captured from a first geo position of a plant in a crop plantation 902, the data indicating: the first geo position; at least one environmental variable at the first geo position from: temperature, humidity, rainfall, soil condition and dewpoint; and an indication of a plant disease, of a first plant at the first geo position. The method 900 comprises predicting, using a machine-learning, ML, model, a likelihood of the disease being present in a second plant at a second geo position different to the first geo position in a predetermined timeframe 904, based on: the received data; a first historical record of the first geo position indicating one or more of: previous plant disease, treatment of previous plant disease, and historical environmental variable values from: temperature, humidity, rainfall, soil condition and dewpoint; a first environmental variable indicating the local environment at the first geo position; a second historical record of a second geo position indicating one or more of: previous plant disease, treatment of previous plant disease, and historical environmental variable values from: temperature, humidity, rainfall, soil condition and dewpoint; and a second environmental variable indicating the local environment of the second geo position. The method 900 comprises providing a disease indicator of the likelihood of the disease being present in the second plant to a treatment unit 906, the disease indicator to cause treatment of the second plant at the second geo location by the treatment unit according to the predicted likelihood of disease, to reduce the likelihood of the disease occurring at the second plant.

The computer-implemented method 1000, for computerised identifying of plant diseases, comprises receiving, as training input, control data from a control plant in experimental control conditions 1002, the control data indicating an image of the control plant, a disease of the control plant in an environment having a set of environmental parameters, and data representing the set of environmental parameters; establishing, from the received training input, a knowledge library of plant diseases according to plant appearance and environmental parameters 1004; subsequently receiving, as use input, a captured image of a crop plantation plant 1006; determining, based on the received captured image and the knowledge library, a disease of the crop plantation plant 1008; and providing, as output, an indication of the crop plantation plant disease in the captured image 1010.

This disclosure also includes computer software which, when executed, is arranged to perform any method disclosed herein. That is, non-transitory, computer-readable storage media storing instructions thereon are included that, when executed by one or more electronic processors, causes the one or more electronic processors to carry out any method disclosed herein. Any computer software or set of computer-readable instructions described herein may be embedded in a computer-readable storage medium (e.g., a non-transitory computer-readable storage medium) that may comprise any mechanism for storing information in a form readable by a machine or electronic processors/computational device. For example, a magnetic storage medium; optical storage medium; magneto optical storage medium; read only memory (ROM); random access memory (RAM); erasable programmable memory (e.g., EPROM and EEPROM); flash memory; or electrical or other types of medium for storing such information/instructions.

It will be appreciated that various changes and modifications can be made to the present invention without departing from the scope of the appended claims.

1. An apparatus comprising:
a processor;
a memory coupled to the processor; and
computer-readable instructions stored on the memory which, when run on the processor, cause the apparatus to:
receive data captured from a first geo position of a plant in a crop plantation, the data indicating:
the first geo position;
at least one environmental variable at the first geo position from: temperature, humidity, rainfall, soil condition and dewpoint; and
an indication of a plant disease, of a first plant at the first geo position;
predict, using a machine-learning, ML, model, a likelihood of the disease being present in a second plant at a second geo position different to the first geo position in a predetermined timeframe, based on:
the received data;
a first historical record of the first geo position indicating one or more of:
previous plant disease, treatment of previous plant disease, and historical environmental variable values from: temperature, humidity, rainfall, soil condition and dewpoint;
a first environmental variable indicating the local environment at the first geo position;
a second historical record of a second geo position indicating one or more of: previous plant disease, treatment of previous plant disease, and historical environmental variable values from: temperature, humidity, rainfall, soil condition and dewpoint; and
a second environmental variable indicating the local environment of the second geo position; and
provide a disease indicator of the likelihood of the disease being present in the second plant to a treatment unit, the disease indicator to cause treatment of the second plant at the second geo location by the treatment unit according to the predicted likelihood of disease, to reduce the likelihood of the disease occurring at the second plant.

2. The apparatus of claim 1, wherein the computer-readable instructions, when run on the processor, cause the apparatus to:
use the trained ML model to predict a likely severity of the disease predicted to be present at the second plant; and
provide a severity indication of the predicted likely severity of the disease being present to the treatment unit, the severity indication to cause treatment of the second crop at the second geo location according to the determined likely severity of the disease.

3. The apparatus of claim 1, wherein the indication of the plant disease is obtained from an artificial intelligence, AI, model, wherein:
the AI model is trained using experimental control data indicating, for each control plant of a plurality of control plants, an image of the control plant, one or more plant diseases or plant disease absence of the control plant, and a plurality of environmental parameters of the control plant, and
the trained AI model receives, as input, a captured image of the first plant, and determines, as output, based on the training data, the indication of the plant disease for the plant in the captured image.

4. The apparatus of claim 1, wherein training the ML model is performed according to:
an initial training phase comprising:
receiving a series of training data entries each indicating, for a training plant:
at least one environmental parameter from: temperature, humidity, rainfall, soil condition and dewpoint;
an indication of a training plant disease; and
a training historical record indicating one or more of: previous training plant disease, treatment of previous training plant disease, and historical training plant environmental variable values from: temperature, humidity, rainfall, soil condition and dewpoint; and
determining relationships between the training data entries to allow for prediction of the likelihood of the plant disease for another plant; and,
optionally, according to a feedback training phase comprising:
receiving a further data entry indicating, for the first plant:
the first geo position;
the at least one environmental variable at the first geo position from: temperature, humidity, rainfall, soil condition and dewpoint;
the indication of a plant disease; and
a first historical record of the first geo position indicating one or more of: previous first plant disease, treatment of previous first plant disease, and historical first plant environmental variable values from: temperature, humidity, rainfall, soil condition and dewpoint; and
determining relationships between the training data entries and the further data entry to allow for prediction of the likelihood of the plant disease for another plant.

5. The apparatus of claim 4, wherein training the ML model comprises:
comparing the prediction of the likelihood of the plant disease obtained in the initial training phase of the ML model with the experimental control data indicating one or more plant diseases or plant disease absence of a control plant, to determine a lag time between the effect of changing a parameter of the set of environmental parameters and a resultant effect on the plant disease; and
providing the determined lag time as input to the ML model for the compared prediction and experimental control data to train the ML model to determine a relationship between a change in an environmental parameter and determined lag time.

6. The apparatus of claim 1, wherein the ML model is configured to use Bayesian probability analysis to predict the likelihood of the disease being present in the second plant in the predetermined timeframe.

7. The apparatus of claim 1, wherein the disease indicator indicates:
the second geo location of the second plant; and
one or more treatment parameters from: the disease type, the treatment substance type, the plant type, a volume of treatment substance to apply, a concentration of treatment substance to apply, a plant location to treat on the second plant; and a treatment schedule indicating when to treat the second plant.

8. The apparatus of claim 1, wherein:
the first plant in the crop plantation has an associated unique identifier; and the computer-readable instructions stored on the memory, when run on the processor, cause the apparatus to:
retrieve the first historical record and the first environmental variable from a database of historical records and a database of environmental variables using the unique identifier; and
store the at least one environmental variable and the indication of a plant disease of the first plant at the first geo position with the unique identifier for subsequent use as training data to train the ML model.

9. A disease recognition apparatus comprising:
a processor;
a memory coupled to the processor; and
computer-readable instructions stored on the memory which, when run on the processor, cause the apparatus to:
receive, as training input, control data from a control plant in experimental control conditions, the control data indicating an image of the control plant, a disease of the control plant in an environment having a set of environmental parameters, and data representing the set of environmental parameters;
establish, from the received training input, a knowledge library of plant diseases according to plant appearance and environmental parameters;
subsequently receive, as use input, a captured image of a crop plantation plant;
determine, based on the received captured image and the knowledge library, a disease of the crop plantation plant; and
provide, as output, an indication of the crop plantation plant disease in the captured image.

10. A device network for agricultural crop treatment, the device network comprising:
the apparatus of claim 9 configured to provide the indication of the crop plantation plant disease;
the apparatus of any of claims 1 to 8 configured to provide the disease indicator of the likelihood of the disease being present in the second plant to a treatment unit; and
the treatment unit configured to receive the disease indicator.

11. The device network of claim 10, further comprising a field device configured to:
capture and transmit the geo position and the at least one environmental parameter at the geo position data in the crop plantation to the apparatus of any of claims 1 to 8; and
capture and transmit, as use input, the captured image of the crop plantation plant to the apparatus of claim 9.

12. The device network of claim 10, wherein the treatment unit comprises a drone configured to:
receive the disease indicator comprising a geo location of the second plant and a treatment to apply to the second plant;
travel to the second plant at the geo location; and
apply the treatment indicated in the disease indicator to the plant.

13. The device network of claim 10, the device network further comprising:
a storage server in communicative connection with the apparatus of any of claims 1 to 8, and the apparatus of claim 9, the storage server configured to store one or more of:
the transmitted captured data from the geo position in the crop plantation; and
training data used to train the AI model.

14. A computer-implemented method comprising:
receiving data captured from a first geo position of a plant in a crop plantation, the data indicating:
the first geo position;
at least one environmental variable at the first geo position from: temperature, humidity, rainfall, soil condition and dewpoint; and
an indication of a plant disease, of a first plant at the first geo position;
predicting, using a machine-learning, ML, model, a likelihood of the disease being present in a second plant at a second geo position different to the first geo position in a predetermined timeframe, based on:
the received data;
a first historical record of the first geo position indicating one or more of: previous plant disease, treatment of previous plant disease, and historical environmental variable values from: temperature, humidity, rainfall, soil condition and dewpoint;
a first environmental variable indicating the local environment at the first geo position,
a second historical record of a second geo position indicating one or more of: previous plant disease, treatment of previous plant disease, and historical environmental variable values from: temperature, humidity, rainfall, soil condition and dewpoint; and
a second environmental variable indicating the local environment of the second geo position; and
providing a disease indicator of the likelihood of the disease being present in the second plant to a treatment unit, the disease indicator to cause treatment of the second plant at the second geo location by the treatment unit according to the predicted likelihood of disease, to reduce the likelihood of the disease occurring at the second plant.

15. A non-transitory computer-readable storage medium having executable instructions stored thereon which, when executed by a processor, cause the processor to:
receive data captured from a first geo position of a plant in a crop plantation, the data indicating:
the first geo position;
at least one environmental variable at the first geo position from: temperature,
humidity, rainfall, soil condition and dewpoint
an indication of a plant disease, of a first plant at the first geo position;
predict, using a machine-learning, ML, model a likelihood of the disease being present in a second plant at a second geo position different to the first geo position in a predetermined timeframe, based on:
the received data;
a first historical record of the first geo position indicating one or more of: previous plant disease, treatment of previous plant disease, and historical environmental variable values from: temperature, humidity, rainfall, soil condition and dewpoint;
a first environmental variable indicating the local environment at the first geo position,
a second historical record of a second geo position indicating one or more of: previous plant disease, treatment of previous plant disease, and historical environmental variable values from: temperature, humidity, rainfall, soil condition and dewpoint; and
a second environmental variable indicating the local environment of the second geo position; and
provide a disease indicator of the likelihood of the disease being present in the second plant to a treatment unit, the disease indicator to cause treatment of the second plant at the second geo location by the treatment unit according to the predicted likelihood of disease, to reduce the likelihood of the disease occurring at the second plant.
